(19) United States
(12) Patent Application Publication
(10) Pub. No.: US 2009/0079672 A1
(43) Pub. Date: Mar. 26, 2009

(54) PLASMA DISPLAY PANEL AND IMAGING DEVICE USING THE SAME

(76) Inventors: Norihiro UEMURA, Hitachi (JP); Shunichiro Nobuki, Kokubunji (JP); Shirun Ho, Tokyo (JP); Keizo Suzuki, Kodaira (JP); Masatoshi Shiiki, Musashimurayama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/175,636

(22) Filed: Jul. 18, 2008

(30) Foreign Application Priority Data
Sep. 21, 2007 (JP) 2007-244645

(51) Int. Cl. G09G 3/28

(52) U.S. Cl. 345/60

(57) ABSTRACT

There is provided a PDP, in which the deterioration in the address discharge timelag with age is suppressed, which is bright, has guaranteed life, can stably be driven, is of low power consumption, high definition, and high image quality. There is provided a pair of sustaining discharge electrodes on the front substrate extending in a row direction for forming a display line, a floating electrode not connected to an external electrode is arranged on the same substrate as the pair of sustaining discharge electrode so as not to pass through a center line extending in a column direction and dividing the discharge cell into two equal parts, thereby intensifying the local potential of an area of the MgO surface not influenced by the sputtering by the sustaining discharge in the address discharge, promoting the electron emission from this area, and suppressing the deterioration of the address discharge timelag.

### CLAIM OF PRIORITY

The present application claims priority from Japanese patent application JP 2007-244645 filed on Sep. 21, 2007, the content of which is hereby incorporated by reference into this application.

### FIELD OF THE INVENTION

The present invention relates to a plasma display panel (hereinafter also referred to as a plasma panel or a PDP), and in particular to a plasma display device including a plasma panel structure capable of reducing an address discharge timelag and deterioration thereof to realize a PDP with high image quality, and a drive device thereof.

### BACKGROUND OF THE INVENTION

In recent years, plasma display devices have become hopeful as color display devices with large screens and low-profile. In particular, alternating-current (AC) coplanar-discharge type PDP, which generates the display discharge between electrodes disposed on the same substrate, and is driven in an alternating-current manner, is the type most advanced in practical applications because of simplicity in structure and high reliability. Hereinafter, a specific example of the ac coplanar-discharge type PDP in the related art will be explained.

FIG. 2 is an exploded perspective view illustrating a part of a structure of a typical ac coplanar-discharge type PDP by way of example. The PDP shown in FIG. 1 has a front panel 21 and a rear panel 28 which are made of glass and affixed together in an integrated manner. The present example is a reflection type PDP in which phosphor layers 32 of red (R)-, green (G)-, and blue (B)-color phosphors are formed on the rear panel 28. The front panel 21 has pairs of sustaining discharge electrodes (sometimes referred to as “display electrodes”) arranged in parallel with each other with a specified spacing therebetween on its surface facing the rear panel 28. Each of the pairs of sustaining discharge electrodes is composed of one of common transparent electrodes (hereinafter referred to merely as X electrodes) (22-1, 22-2, . . . ) and one of independent transparent electrodes (hereinafter referred to merely as Y electrodes or scanning electrodes) (23-1, 23-2, . . . ). Further, for the purpose of supplementing the electric conductivity of the transparent electrodes, the X electrodes (22-1, 22-2, . . . ) and the Y electrodes (23-1, 23-2, . . . ) are overlaid with opaque X bus electrodes (24-1, 24-2, . . . ) and opaque Y bus electrodes (25-1, 25-2, . . . ) extending in a direction of an arrow D2 indicated in FIG. 2, respectively. Further, for the ac driving, the X electrodes (22-1, 22-2, . . . ), Y electrodes (23-1, 23-2, . . . ), X bus electrodes (24-1, 24-2, . . . ), and Y bus electrodes (25-1, 25-2,. . . ) are insulated from the discharge. More specifically, each of these electrodes is covered with a dielectric layer 26 typically formed of a low-melting glass layer, and the dielectric layer 26 is covered with a protective film 27.

The rear panel 28 is provided with address electrodes 29 (hereinafter referred to merely as “A electrodes”) disposed on its surface facing the front panel 21, so as to be spaced from and extend perpendicularly to the X electrodes (22-1, 22-2, . . . ) and Y electrodes (23-1, 23-3, . . . ) of the front panel 21, and the A electrodes are covered with a dielectric layer 30. The A-electrodes 29 are disposed so as to extend in a direction (the column direction) of an arrow D1 shown in FIG. 2. On the dielectric layer 30, there are disposed partitions (ribs) 31 for separating the A-electrodes 29 from each other, thereby preventing the discharge from spreading (defining an area of the discharge). Red-, green-, and blue-light emitting phosphor layers 32 are applied sequentially in the shape of stripes on surfaces of corresponding grooves formed between the partitions 31.

FIG. 3 is a cross-sectional view of a substantial part of the PDP as viewed in the direction of the arrow D2 in FIG. 2, and illustrates one discharge cell serving as the smallest unit of a pixel. In the drawing, boundaries between the discharge cells are schematically indicated by broken lines. The reference numeral 33 denotes a discharge space filled with a discharge gas for generating plasma. When a voltage is applied between the electrodes, plasma 10 is generated by ionization of the discharge gas.

FIG. 3 schematically shows a condition in which the plasma 10 is generated. Ultraviolet rays from the plasma excite the phosphors 32 to emit light, and the light from the phosphors 32 passes through the front panel 21 such that an image display is produced by a combination of light from the respective discharge cells.

FIG. 4 is a schematic illustration of movements of charged particles (positive or negative particles) in the plasma 10 shown in FIG. 3. In FIG. 4, the reference numerals 3 denote particles with a negative charge (e.g., electrons), the reference numeral 4 denotes a particle with a positive charge (e.g., a positive ion), the reference numeral 5 denotes a positive wall charge and the reference numerals 6 denote negative wall charges. The drawing illustrates a state of charges at an instant of time during the operation of the PDP, and the arrangement of the charges does not have any particular meaning.

FIG. 4 is a schematic illustration showing, by way of example, the state in which discharge has started and then ceased in response to application of a negative voltage to the Y electrode 23-1 and of a (relatively) positive voltage to both the A electrode 29 and the X electrode 22-1. As a result, formation of wall charges (which is called “writing”) has been performed which assists start of discharge between the Y electrode 23-1 and the X electrode 22-1. When an appropriate inverse voltage is applied between the Y electrode 23-1 and the X electrode 22-1 on this occasion, discharge occurs in a discharge space between the both electrodes via the dielectric layer 26 (and the protective film 27). After cessation of the discharge, when the voltage applied between the Y electrode 23-1 and the X electrode 22-1 are reversed, another discharge occurs. The discharge can be produced continuously by repeating the operation described above. This is called the sustaining discharge.

FIGS. 5A to 5C are diagrams showing the operation during one TV field period required for displaying one frame on the PDP shown in FIG. 2. FIG. 5A is a time chart. As shown in (I), one TV field period 40 is divided into a plurality of sub-fields 41 through 48 having different number of times of light emission from one another. The gray scale is represented by selecting either one of emission and non-emission in each of the sub-fields. As shown in (II), each of the sub-fields has a resetting period 49, an address discharge period 50 for determining a light-emitting cell, and a sustaining discharge period 51.

FIG. 5B shows voltage waveforms applied to the A electrodes, X electrodes and Y electrodes during the address discharge period 50 of FIG. 5A. A voltage waveform 52 is a waveform of a voltage applied to one of the A electrodes during the address discharge period 50, a voltage waveform 53 is a waveform of a voltage applied to the X electrodes, and voltage waveforms 54 and 55 are waveforms of voltages applied to the ith and (i+1)th Y electrodes, respectively, and the above voltages are denoted by V0, V1, and V2 (V), respectively. In FIG. 5B, a width of the voltage pulse applied to the A electrodes is indicated by tₐ. According to FIG. 5B, when a scan pulse 56 is applied to the ith Y electrode, the address discharge occurs in the cell located at an intersection of the ith Y electrode and the A electrode 29. Further, even when the scan pulse 56 is applied to the ith Y electrodes, the address discharge does not occur if the A electrode 29 is at ground potential (GND). In this way, the scan pulse 56 is applied once to the Y electrode during the address discharge period 50, and in synchronism with the scan pulse 56, the A electrode 29 of the cell intended to produce light is supplied with the voltage V0, and the A electrode of the cell not intended to produce light is set to the ground potential. In the discharge cell where the address discharge has occurred, the charges produced by the discharge are provided on the surfaces of the dielectric layer and the protective film covering the Y electrodes. With the aid of an electric field generated by the charges, on-or-off control of the sustaining discharge can be obtained as described later. That is to say, the discharge cells having produced the address discharge serve as light emitting cells, and the remainder of the cells serves as dark cells.

FIG. 5C shows voltage pulses applied all of the X electrodes and Y electrodes which serve as the sustaining discharge electrodes during the sustaining discharge period 51 in FIG. 5A. A voltage waveform 58 is applied to the X electrodes and a voltage waveform 59 is applied to the Y electrodes. The pulses with the voltage of V3 (V) of the same polarity are applied alternately to the X electrodes and Y electrodes, and consequently, reversal of the polarity of the voltage between the X and Y electrodes is repeated. The discharge caused in the discharge gas between the X electrodes and Y electrodes generated during this period is called the sustaining discharge. The sustaining discharge is performed alternately in a pulsed manner.

Further, as described in JP-A-2006-216556 and JP-A-2006-147538, regarding the electrode structure, there is proposed a structure of using a floating electrode disposed inner from the X electrodes and Y electrodes in parallel to the X electrodes and Y electrodes for the purpose of improvement in brightness, reduction of the discharge starting voltage, reduction of the manufacturing cost, and improvement in image quality. Still further, as described in JP-A-2001-216902, there is also proposed a structure of using a floating electrode in a part opposed to the partition for the purpose of effectively preventing interference in discharge between the discharge cells adjacent to each other, and thereby performing stable image display. Further, as described in JP-A-2001-6564 and JP-A-2002-343257, there is also proposed a structure of arranging the area where the sustaining discharge electrodes used as the scan electrodes are opposed to the address electrodes is larger than the area where the sustaining discharge electrode not used as the scan electrodes are opposed to the address electrodes.

### SUMMARY OF THE INVENTION

In the case in which it is attempted to achieve the PDP, which is bright, has guaranteed life, can be driven stably, and is of low power consumption, high definition, and high image quality, the address discharge timelag becomes a bottleneck. If the address discharge timelag becomes large, a failure in the address discharge is caused, and the subsequent sustaining discharge fails, thus causing flickers on the screen. Further, in addition, driving the PDP for a long period of time causes the problem (deterioration with age) of increasing the address discharge timelag. Specifically, when the PDP is kept on for a long period of time, the flickers on the screen occur to cause degradation of the image quality.

As described in JP-A-2006-216556 and JP-A-2006-147538, there is proposed a structure of using the floating electrode disposed inner from the X electrodes and Y electrodes in parallel to the X electrodes and Y electrodes. However, in such a structure, since the floating electrode is disposed so as to traverse the center section of the discharge cell for the purpose of supporting the sustaining discharge, deterioration of an MgO surface on the floating electrode is caused by the sustaining discharge, thus making it quite difficult to prevent the deterioration of the address discharge timelag with age. Further, the deterioration of the address discharge timelag is not improved even by using the floating electrode to the part opposed to the partition as described in JP-A-2001-216902. Further, even if the area where the sustaining discharge electrodes used as the scan electrodes are opposed to the address electrodes is arranged to be larger than the area where the sustaining discharge electrode not used as the scan electrodes are opposed to the address electrodes as described in JP-A-2001-6564 and JP-A-2002-343257, the positive effect of the floating electrode can hardly be obtained because the floating electrode is not disposed at an appropriate place.

The present invention has been made in view of the circumstances described above, and has an object of improving the deterioration of the address discharge timelag with age, thereby providing a PDP, which is bright, has guaranteed life, can be driven stably, and is of low power consumption, high definition, and high image quality.

A summary of representative aspects of the invention disclosed in the present specification will be explained below.

According to a first aspect of the present invention, there is provided a plasma display panel, including a plurality of discharge cells each having a front substrate, a bus electrode, a pair of sustaining discharge electrodes provided to the front substrate disposed in parallel to each other in a direction perpendicular to the longitudinal direction of the bus electrode, and for forming a display line, a dielectric layer for covering the pair of sustaining discharge electrodes, a rear substrate, and an address electrode provided to the rear substrate so as to be opposed to the pair of sustaining discharge electrodes, and extending in a direction perpendicular to the longitudinal direction of the bus electrode, and a plurality of partitions for separating the plurality of discharge cells, wherein a floating electrode is disposed on the same substrate as the pair of sustaining discharge electrodes so as not to pass through a center line coplanar with the floating electrode extending in a direction perpendicular to the longitudinal direction of the bus electrode and dividing the discharge cell into two equal parts.

According to a second aspect of the present invention, in the plasma display panel according to the first aspect of the invention, a length of the floating electrode in the longitudinal direction of one bus electrode is 20% of a width of the discharge cell in the longitudinal direction excluding the partitions.

According to a third aspect of the present invention, in the plasma display panel according to the first aspect of the invention, the floating electrode is formed of one of a transparent conductive film and a metal film.

According to a fourth aspect of the present invention, in the plasma display panel according to the first aspect of the invention, the floating electrode is formed in the same layer as the pair of sustaining discharge electrodes.

According to a fifth aspect of the present invention, in the plasma display panel according to the first aspect of the invention, the floating electrode is made of the same material as the pair of sustaining discharge electrodes.

According to a sixth aspect of the present invention, in the plasma display panel according to the first aspect of the invention, the dielectric layer is mainly composed of a grass layer, and an MgO film covering the glass layer.

According to a seventh aspect of the present invention, in the plasma display panel according to any one of the first through the sixth aspects of the invention, the floating electrode is formed continuously to the contiguous discharge cell in the longitudinal direction of the bus electrode.

According to an eighth aspect of the present invention, in the plasma display panel according to any one of the first through the seventh aspects of the invention, the shortest distance between the pair of sustaining discharge electrodes and the floating electrode is substantially a half of the thickness of the dielectric layer.

According to a ninth aspect of the present invention, in the plasma display panel according to any one of the first through the eighth aspects of the invention, the thickness of the dielectric layer is equal to or smaller than 25 μm.

According to a tenth aspect of the present invention, in the plasma display panel according to any one of the first through the ninth aspects of the invention, the address electrode is formed so that projective components of the floating electrode and the address electrode in a direction perpendicular to the rear substrate overlap with each other.

According to an eleventh aspect of the present invention, there is provided a plasma display panel, including a plurality of discharge cells each having a front substrate, a bus electrode, a pair of sustaining discharge electrodes provided to the front substrate disposed in parallel to each other in a direction perpendicular to the longitudinal direction of the bus electrode, and for forming a display line, a dielectric layer for covering the pair of sustaining discharge electrodes so that the pair of sustaining discharge electrodes are opposed to each other with a predetermined gap, a rear substrate, and an address electrode provided to the rear substrate so as to be opposed to the pair of sustaining discharge electrodes, and extending in a direction perpendicular to the longitudinal direction of the bus electrode, and a plurality of partitions for separating the plurality of discharge cells, wherein the floating electrode is formed in another area than the gap.

According to a twelfth aspect of the present invention, in the plasma display panel according to the eleventh aspect of the invention, the floating electrode is formed of one of a transparent conductive film and a metal film.

According to a thirteenth aspect of the present invention, in the plasma display panel according to the eleventh aspect of the invention, the floating electrode is formed in the same layer as the pair of sustaining discharge electrodes.

According to a fourteen aspect of the present invention, in the plasma display panel according to the eleventh aspect of the invention, the floating electrode is made of the same material as the pair of sustaining discharge electrodes.

According to a fifteenth aspect of the present invention, in the plasma display panel according to the eleventh aspect of the invention, the dielectric layer is mainly composed of a grass layer, and an MgO film covering the glass layer.

According to a sixteenth aspect of the present invention, in the plasma display panel according to any one of the eleventh through the fifteenth aspects of the invention, the floating electrode is formed continuously to the contiguous discharge cell in the longitudinal direction of the bus electrode.

According to a seventeenth aspect of the present invention, in the plasma display panel according to any one of the eleventh through the sixteenth aspects of the invention, the shortest distance between the pair of sustaining discharge electrodes and the floating electrode is substantially a half of the thickness of the dielectric layer.

According to an eighteenth aspect of the present invention, in the plasma display panel according to any one of the eleventh through the seventeenth aspects of the invention, the thickness of the dielectric layer is equal to or smaller than 25 μm.

According to a nineteenth aspect of the present invention, in the plasma display panel according to any one of the eleventh through the eighteenth aspects of the invention, the address electrode is formed so that projective components of the floating electrode and the address electrode in a direction perpendicular to the rear substrate overlap with each other.

According to a twentieth aspect of the present invention, there is provided an imaging system using the plasma display panel according to any one of the first through the nineteenth aspects of the invention.

By applying the above aspects of the present invention, there can be provided a PDP, in which the deterioration in the address discharge timelag with age can be improved, which is bright, has guaranteed life, can stably be driven, is of low power consumption, high definition, and high image quality.

### BRIEF DESCRIPTION OF THE DRAWINGS

FIG. 1 is a diagram showing a discharge cell or a part of a discharge cell of a PDP according to an embodiment of the present invention;

FIG. 2 is an exploded perspective view showing a part of an ac coplanar-discharge type PDP with a structure of the related art;

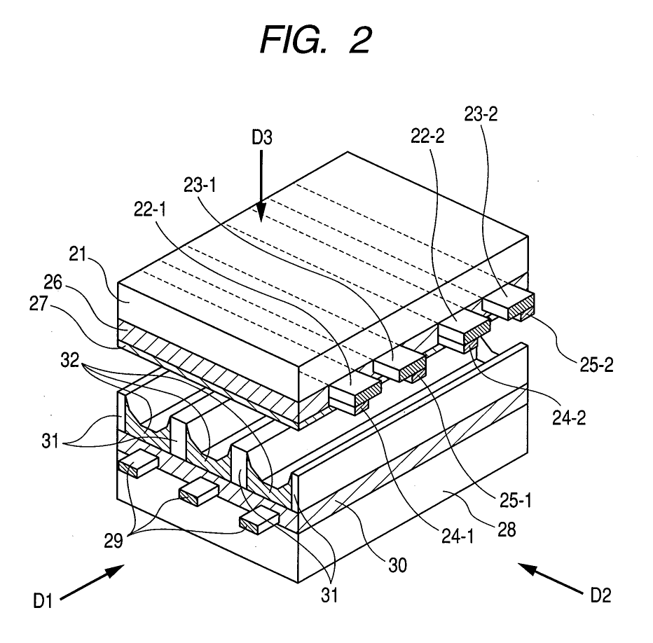

FIG. 3 is a cross-sectional view of the structure of the PDP shown in FIG. 2;

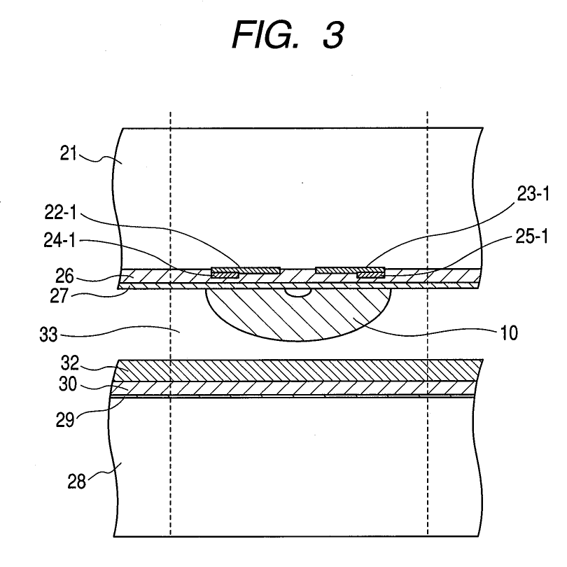

FIG. 4 is a diagram schematically showing the movements of the charged particles located inside the plasma 10 shown in FIG. 3;

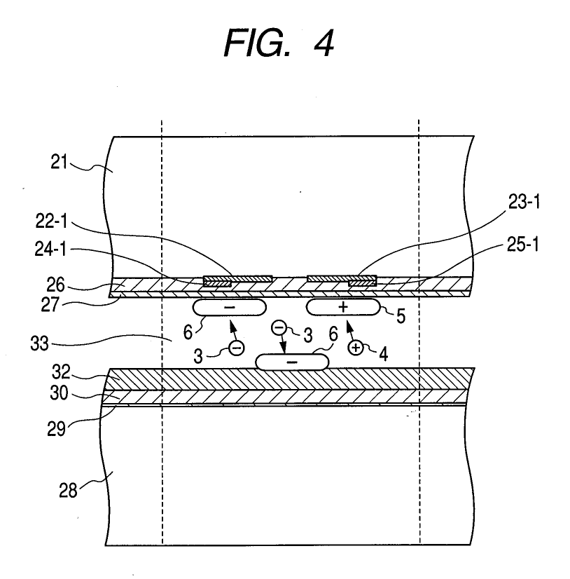

FIGS. 5A through 5C are charts each showing an operation in one TV field period for displaying a frame on the PDP;

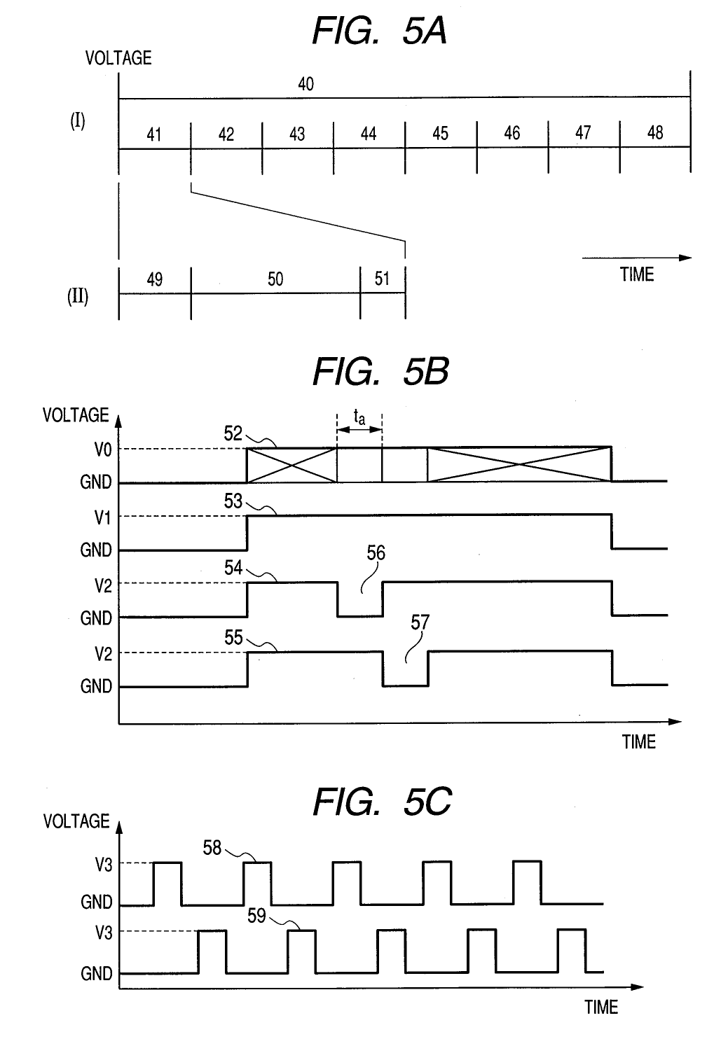

FIG. 6 is a diagram showing a concept of the discharge timelag;

FIGS. 7A and 7B are diagrams showing a result of the observation of the enlarged MgO surface condition, wherein FIG. 7A shows the condition of the MgO surface prior to a life test, and FIG. 7B shows the condition of a part thereof deteriorated by the life test;

FIGS. 8A and 8B are diagrams showing the condition of discharge traces in the discharge cell, wherein FIG. 8A shows the condition inside the discharge cell prior to the life test, and FIG. 8B shows the condition inside the discharge cell after the life test;

FIGS. 9A through 9D show cross-sectional views of the front substrate 21 shown in FIG. 1, wherein FIGS. 9A and 9B are cross-sectional views along the dashed lines T-T′ and U-U′, respectively, and FIGS. 9C and 9D are cross-sectional views along the chain double-dashed lines V-V′ and W-W′, respectively;

FIGS. 10A and 10B are diagrams showing a discharge cell or a part of a discharge cell of a PDP according to an embodiment of the present invention, and showing the condition of the discharge traces, wherein h1 is 32 μm in FIG. 10A, or 15 μm in FIG. 10B;

FIGS. 11A and 11B are diagrams each representing a result of calculation of the potential distribution on a surface of the protective film, wherein the h1 is 32 μm in FIG. 11A, or 15 μm in FIG. 11B;

FIG. 12 is a diagram showing a result of measurement of the number M₀ of seed electrons after the life test with the h1 varied;

FIG. 13 is a diagram showing the optimum relationship between dnₘᵢₙ and the h1;

FIGS. 14A and 14B are diagrams showing a discharge cell or a part of a discharge cell of a PDP according to an embodiment of the present invention;

FIGS. 15A through 15I are diagrams showing a discharge cell or a part of a discharge cell of a PDP according to an embodiment of the present invention;

FIGS. 16A and 16B are diagrams showing a discharge cell or a part of a discharge cell of a PDP according to an embodiment of the present invention;

FIGS. 17A through 17C are diagrams showing a discharge cell or a part of a discharge cell of a PDP according to an embodiment of the present invention;

FIGS. 18A through 18D are diagrams showing a discharge cell or a discharge gap of a discharge cell of a PDP according to an embodiment of the present invention; and

FIG. 19 is a diagram showing an imaging system using a PDP.

### DETAILED DESCRIPTION OF THE PREFERRED EMBODIMENTS

Hereinafter, some embodiments of the present invention will be explained in detail with reference to the accompanying drawings. It should be noted that in all of the drawings for explaining the embodiments of the invention, those having the same function are denoted with the same reference numerals, and redundant explanations therefor will be omitted.

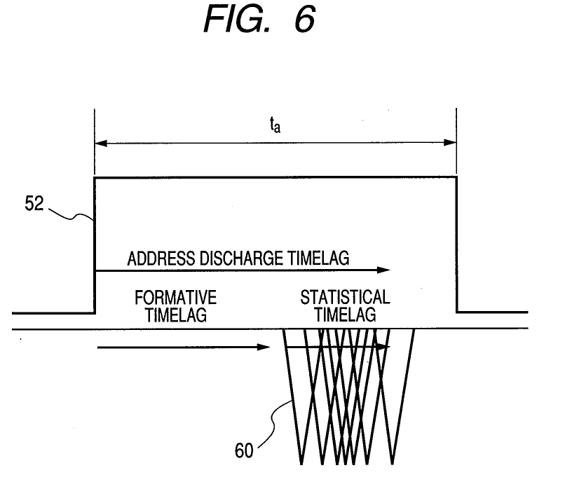

Firstly, the address discharge timelag will be described. FIG. 6 shows a schematic diagram showing the condition of the address discharge timelag. The address discharge timelag t_{d} is a time period from when the voltage waveform has been applied to when the address discharge occurs. Further, the address discharge timelag is divided into a formative timelag t_{f} and a statistical timelag tₛ, and is defined as follows.

[Formula 1]

t_{d}=t_{f}+tₛ (1)

Here, the formative timelag t_{f} is a period of time from when the seed electron to be a seed of the discharge has been generated to when the discharge occurs, and the statistical timelag tₛ is a period of time from when the voltage equal to or higher than the discharge starting voltage has been applied to when the seed electron is generated. Further, as shown in FIG. 6, the address discharge timelag varies when the same measurement is repeatedly executed, and the varied address discharge timelags have a distribution. Therefore, in order for obtaining the discharge timelag from the results of the experiment, the following method is required. Specifically, assuming that the frequency at which the discharge occurs at a time point tᵢ is n(tᵢ), the number of times N(t) of occurrence of the discharge before the time point t can be represented as follows.

$$\begin{matrix}\text{[Formula 2]} & \\ N ( t ) = {\sum }_{{t}_{i}}^{t} n ( {t}_{i} ) & ( 2 )\end{matrix}$$

Here, assuming that the number of times of measurement is N₀, the formative timelag t_{f} and the statistical timelag tₛ can be represented as follows.

[Formula 3]

1−N(t)/N₀=exp(−(t−t_{f})/tₛ) (t≧t_{f}) (3)

Therefore, the formative timelag t_{f} and the statistical timelag tₛ can be obtained from the intercept and the gradient of a graph obtained by plotting values obtained by calculating the logarithm of 1−N(t)/N₀, which is obtained by the experiment. As shown in FIG. 6, the formative timelag corresponding to the time elapsed until the distributions of the discharge start in a plurality of times of measurement, and the statistical timelag is a period of time corresponding to the widths of the distributions of the discharge. The formative timelag t_{f} and the statistical timelag tₛ are the values necessary for understanding the discharge timelag phenomenon.

Further, in Formula 3, in the case in which the statistical timelag ts is sufficiently large, the statistical timelag independent of a fluctuation component of the formative timelag, namely a fluctuation component of the formative timelag caused by a variation in forming the wall charge and a variation in the seed electron generation position, can be obtained.

[Formula 4]

H(t)=1−N(t)/N₀ (4)

Specifically, assuming that Formula 4 works out, the period of time with which the H(t) becomes large enough not to be influenced by the fluctuation component of the formative timelag is equal to or longer than a period of time with which the H(t) becomes 0.6, the period of time with which the H(t) becomes 0.6 is t_{—}_{^{0.6}}, and the period of time with which the H(t) becomes 0.99 is t_{—}_{^{0.99}}, the statistical time lag ts can be represented as follows.

$$\begin{matrix}\text{[Formula 5]} & \\ H ( t\_ 0.6 ) = 1 - N ( t\_ 0.6 ) / {N}_{0} = 0.6 & ( 5 ) \\ \text{[Formula 6]} & \\ H ( t\_ 0.99 ) = 1 - N ( t\_ 0.99 ) / {N}_{0} = 0.99 & ( 6 ) \\ \text{[Formula 7]} & \\ {t}_{s} = ( t\_ 0.99 - t\_ 0.6 ) / 1 n \frac{H ( t\_ 0.6 )}{H ( t\_ 0.99 )} & ( 7 )\end{matrix}$$

Here, as shown in FIG. 6, assuming that the voltage pulse width applied to the address electrode is tₐ, since the failure occurs in the address discharge to cause the flickers in the display unless all of the discharge in the plurality of times of measurement occurs within the period of time tₐ, it is required that all of the discharge falls within the address pulse.

Further, in the life test in which the PDP is continuously driven to be kept on, the address timelag, in particular the statistical timelag, is significantly increased. Thus, a failure in keeping the all of the discharge within the address pulse is caused resulting in the flickers in the display.

A detailed investigation has been conducted on the deterioration mechanism in the life test. As described above, the statistical timelag is the period of time from when the voltage equal to or higher than the discharge stating voltage has been applied to the electrodes to when the seed electron is generated. The seed electron to be the seed of the discharge is generated when the electron captured in the trapping level existing at a level slightly lower than the conduction band between the valence band and the conduction band of MgO jumps out to the discharge space owing to an electric field effect of the Auger process. The capturing of the electron in the trapping level is performed in the discharge prior to the address discharge by the vacuum ultraviolet irradiation on MgO, or collision of the charged particle to MgO. The longer the time elapsed from the discharge prior to the address discharge becomes, the fewer the number of the electrons captured in the trapping level becomes, and the fewer the number of seed electrons generated from the MgO surface becomes.

The number of the seed electrons can be obtained as follows. Assuming that the number of the seed electrons generated by the discharge prior to the address discharge is M₀, and a time constant of generation (decrement of the captured electrons) of a single seed electron is τ, the number M(t) of the seed electrons with the elapsed time t after the previous discharge can be represented as follows.

[Formula 8]

M(t)=M₀ exp(−t/τ) (8)

Here, using the M(t) and τ, the statistical timelag tₛ obtained by the experiment can be represented as follows.

[Formula 9]

tₛ=τ/M(t) (9)

Therefore, according to Formulas 8 and 9, the following can be obtained.

[Formula 10]

ln(1/tₛ)=ln(M₀/τ)−t/τ (10)

Here, by measuring the statistical timelag tₛ while varying the elapsed time t after the discharge prior to the address discharge, and plotting the result, the M₀ and the τ can be obtained from the intercept and the gradient thereof.

As a result, it proved that the number M0 of the seed electrons generated by the discharge prior to the address discharge was 1.0×10⁶, and the time constant τ of generation of a single seed electron was 90 ms. Further, after executing continuous lighting for 1000 hours at 70 kHz, the M0 was 5.0×10⁴, and the τ was 90 ms. In other words, it proved that the number of the seed electrons generated in the discharge prior to the address discharge became 1/20 while the frequency 1/τ of generation of a single seed electron was maintained. As described above, the seed electron is generated when the electron captured in the trapping level jumps out to the discharge space, and the capturing of the electron to the trapping level is performed in the discharge prior to the address discharge by the vacuum ultraviolet irradiation to MgO or the collision of the charged particle to MgO. Here, since there is almost no variation in the intensity of the discharge even after the continuous lighting for 1000 hours at 70 kHz is executed, it can be understood that the energy intensity of the vacuum ultraviolet irradiation or the charged particles for capturing the electrons in the trapping level is not reduced. In other words, the reduction of the number of seed electrons emitted to the discharge space is caused by reduction of the number of the trapping levels themselves. According to the above facts, it proved that the cause of the increase in the statistical timelag by the life test was the decrease in the number of seed electrons emitted from MgO caused by the decrease in the number of trapping levels in MgO.

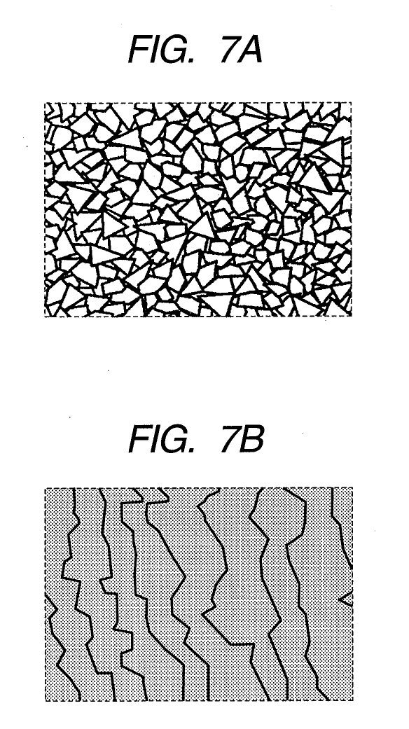

Subsequently, investigation of a factor causing the decrease in the number of trapping levels in MgO was conducted. FIGS. 7A and 7B show the result of observation of the surface condition of MgO before and after the life test magnified fifty thousand times. FIG. 7A shows the condition of the surface of MgO before the life test, and FIG. 7B shows the condition of a deteriorated part after the life test. It proved that on the surface shown in FIG. 7A, there remained a clean crystal of MgO on one hand, and the surface shown in FIG. 7B was scaled and crystallinity was lost from the surface, on the other hand. As described above, the trapping levels are formed at positions slightly lower than the conduction band in the band structure of the MgO crystal, and in order for existing such levels, it is required that MgO is crystallized. The reason why the crystallinity is lost by the life test is that the crystal is broken by ions in the plasma colliding against the MgO surface.

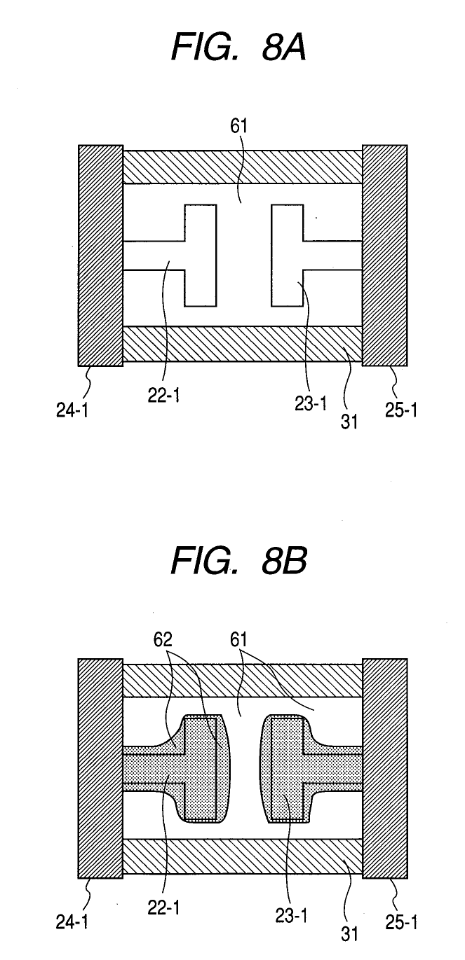

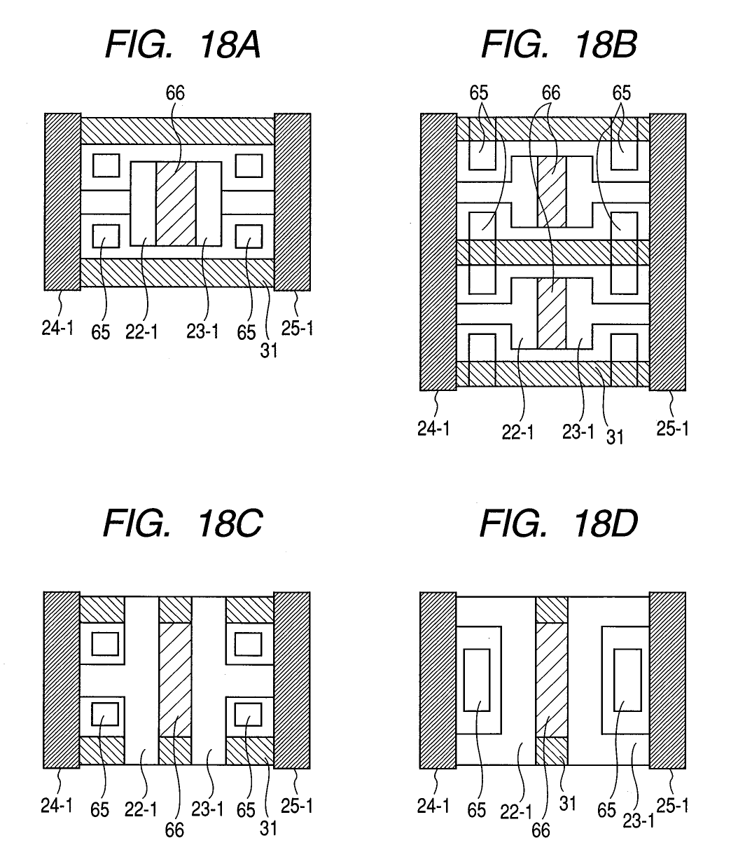

FIGS. 8A and 8B show the result of observation of the condition of the distribution of the MgO surface condition in the discharge cell. FIG. 8A shows the condition inside the discharge cell before the life test, and FIG. 8B shows the condition inside the discharge cell after the life test. Although the X electrode and the Y electrode have T-shapes, the T-shapes are not particularly required. As shown in the drawings, a pair of sustaining discharge electrodes (the X electrode 22-1 and the Y electrode 23-1) are opposed to each other with a predetermined gap interposed therebetween. The gap interposed between the both electrodes is referred to as a discharge gap 66. FIGS. 18A through 18D each show an example of the discharge gap 66. In the drawings, the discharge gap is illustrated with cross-hatching.

As shown in FIG. 8B, it can be understood that traces called discharge traces are formed on the electrodes and the vicinity thereof after the life test. These parts are the parts shown in FIG. 7B where the crystallinity is lost from the surface of MgO. An area of the discharge cell where the discharge is generated and grows effectively without blocked by the ribs and so on is defined as an effective discharge area.

In the effective discharge area, the proportion of the area where such discharge traces were formed was 65%. In other words, it proved that the remaining 35% thereof has the clean MgO crystal shown in FIG. 7A remaining thereon.

Here, as described above, it proved that the seed electrons generated in the address discharge were generated mainly from MgO in the area of the discharge traces, namely on the electrode and the periphery thereof, and almost no seed electron was emitted from MgO in the part to which an electric field as intensive as the electric field on the electrode was not applied in the address discharge, judging from the fact that the number of seed electrons from the MgO surface generated in the discharge prior to the address discharge became 1/20, and the fact that the clean MgO crystal remains 35% of the effective discharge area.

Therefore, by arranging that the electric field is effectively applied to the areas other than the area where the discharge traces are formed, namely to the area where the clean MgO crystals remain, the seed electrons can effectively be generated, thus the discharge timelag can be improved.

Based on the above concept, the following experiments were conducted.

### First Embodiment

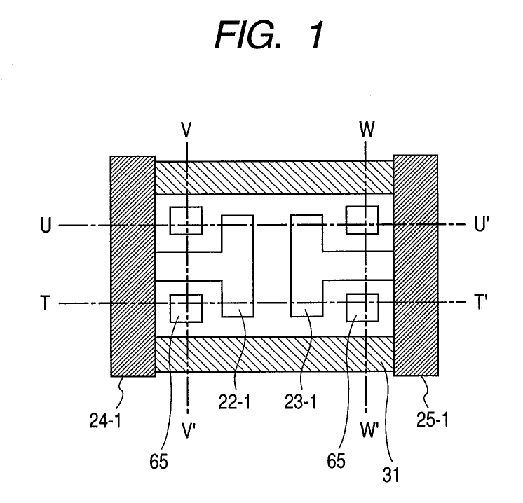

FIG. 1 shows an embodiment related to the present invention, and is a diagram showing an electrode structure of one discharge cell. As shown in FIG. 1, electrodes not connected to a circuit are disposed in the discharge cell. Hereinafter, the electrodes are referred to as floating electrodes 65. The floating electrodes include those connected merely to the ground potential. A 42-inch PDP with such electrode shapes was manufactured, and the evaluation was executed taking the PDP having the electrode structure shown in FIG. 8A as a target of comparison. These PDPs were formed to have the dielectric layers 26 with a thickness of 32 μm. Further, the PDPs were formed to have the shortest distance of 16 μm between the X electrode 22-1 or the X bus electrode 24-1 and the floating electrode 65 on the X electrode side in the area where the X electrode 22-1 or the X bus electrode 24-1 and the floating electrode 65 on the X electrode side were closest, and similarly, the shortest distance of 16 μm between the Y electrode 23-1 or the Y bus electrode 25-1 and the floating electrode 65 on the Y electrode side in the area where the Y electrode 23-1 or the Y bus electrode 25-1 and the floating electrode 65 on the Y electrode side were closest.

The results obtained are shown in Table 1. The address discharge timelag t_{d}, the formative timelag t_{f}, and the statistical timelag tₛ were the values with the elapsed time t after the previous discharge of 16 ms. Further, the results were obtained with the life test in which the lighting period of time was 1000 hours, and the frequency was 70 kHz.

TABLE 1

| | LIGHTING | | | | | τ |
|---|---|---|---|---|---|---|
| | PERIOD (h) | t_{d} (μs) | t_{f} (μs) | tₛ (μs) | M₀ | (ms) |
| PRESENT | 0 | 0.65 | 0.43 | 0.22 | 1.1 × 10⁶ | 90 |
| INVENTION | 1000 | 1.32 | 0.44 | 0.88 | 2.8 × 10⁵ | 90 |
| (FIG. 1) | | | | | | |
| STRUCTURE | 0 | 0.69 | 0.44 | 0.25 | 1.0 × 10⁶ | 90 |
| OF | 1000 | 4.90 | 0.45 | 4.45 | 5.0 × 10⁴ | 90 |
| RELATED | | | | | | |
| ART (FIG. | | | | | | |
| 8A) | | | | | | |

As is understood from the table, since the number M₀ of the seed electrons becomes 1/20 after the 1000 hour life test in the structure of the related art, the statistical timelag tₛ becomes as very large as 4.45 μs, thus the flickers in the display are caused by miss addressing. In contrast, it proves that according to the electrode structure of the present embodiment of the invention, the number M₀ of the seed electrons after the 1000 hour life test becomes only ¼, thus the statistical timelag tₛ can significantly be reduced to 0.88 μs. Therefore, by using the electrode structure of the embodiment of the invention, the sufficient address discharge is possible, thus the display performance can be assured without causing the flickers in the display. The reason why the deterioration in the address discharge timelag, in particular in the statistical timelag with age can be reduced by using the electrode structure of the embodiment of the invention as described above is as follows.

As described above, the reason why the number M0 of the seed electrons is reduced after the life test is that the crystals of MgO are broken, thus the trapping level involved in the electron emission is lowered. Further, in order for making the electrons be emitted from the part where the crystals of MgO are not broken, application of an intensive electrical field is required. Alternatively, it is required that the intensive electrical field is locally applied to the tip of a fine structure of the MgO surface. According to the electrode structure of the embodiment of the present invention, although the MgO crystals on the X electrode and the Y electrode are broken by sputtering with the sustaining discharge, the MgO crystals on the floating electrodes are not sputtered with the sustaining discharge, and remain as clean crystals after the life test because the MgO crystals on the floating electrodes are insulated from the circuit. Further, in the address discharge, since an intensive electrical field (including an intensive local electrical field) is induced on the MgO surface by electrostatic induction to promote generation of the seed electrons, the seed electrons are effectively generated, and this state is maintained after the life test.

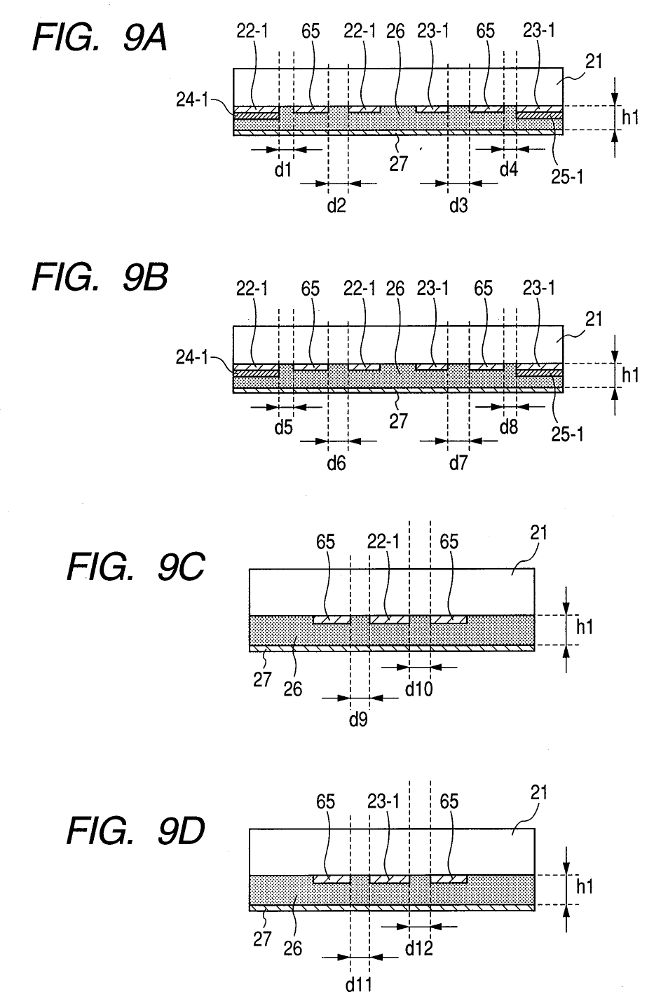

FIGS. 9A through 9D show the cross-sectional views of the structure shown in FIG. 1. FIGS. 9A and 9B are cross-sectional views along the dashed lines T-T′ and U-U′, respectively, and FIGS. 9C and 9D are cross-sectional views along the chain double-dashed lines V-V′ and W-W′, respectively. Here, dn (n=1, 2, . . . , 12) represent the shortest distances between the X electrode 22-1, the X bus electrode 24-1, the Y electrode 23-1, or the Y bus electrode 25-1 and the floating electrodes 65 as shown in the drawings. Further, the h1 denotes the thickness of the dielectric layer 26. The result of the study about the thickness of the dielectric layer and the lengths of the dn will be explained in a second embodiment of the invention.

Although the floating electrodes 65 are made of the same material as the material of the X electrode 22-1 and the Y electrode 23-1, the same material as the material of the X bus electrode 24-1 and the Y bus electrode 25-1 can also be used. Further, any materials can be used providing the materials cause the electrostatic induction. Further, although the floating electrodes 65 are formed in the same layer as the layer of the X electrode 22-1 and the Y electrode 23-1, the floating electrodes 65 can also be formed in the same layer as the layer of the X bus electrode 24-1 and the Y bus electrode 25-1. Alternatively, the floating electrodes 65 can also be formed between the dielectric layer 26 and the protective film 27.

### Second Embodiment

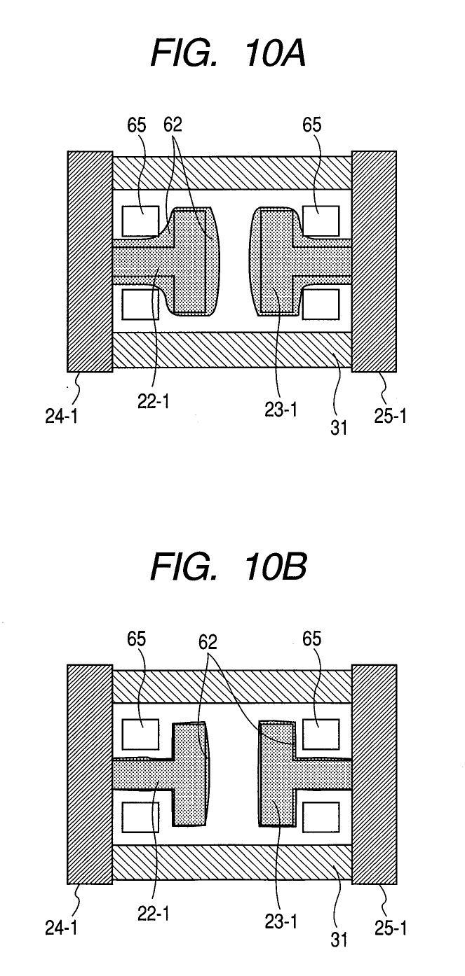

FIGS. 10A and 10B show an embodiment related to the present invention, and are diagrams showing an electrode structure of one discharge cell. As shown in the drawings, the electrodes insulated from the circuit are disposed inside the discharge cell in a floating manner. The condition of the discharge traces 62 after the life test for 1000 hours at 70 kHz is shown in the drawings. FIG. 10A shows a PDP with the h1 of 32 μm, and FIG. 10B shows the case with a PDP with the h1 of 15 μm.

As is understood from the drawings, in the case with the h1 of 32 μm, it can be appreciated that the discharge traces 62 run off the electrodes. On the other hand, in the case with the h1 of 15 μm, it can be appreciated that the discharge traces 62 substantially overlap the electrodes. The reason why the shapes of the discharge traces vary in accordance with the h1 even if the shapes of the electrodes are the same is as follows.

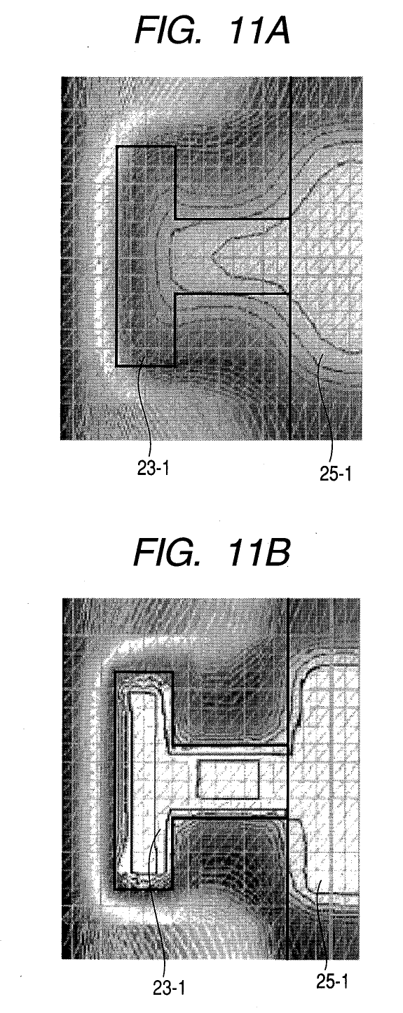

When a voltage is applied to the X electrode and the Y electrode, electrical potential is formed in the discharge space via the dielectric layer 26 and the protective layer 27. FIGS. 11A and 11B show diagrams representing calculation results of the potential distribution on the surface of the protective layer. FIG. 11A shows the case with the h1 of 32 μm, and FIG. 11B shows the case with the h1 of 15 μm. As is understood from the drawings, it can be appreciated that in the case in which the thickness of the dielectric layer 26 is small, the potential distribution in the discharge space (or the surface of the protective layer 27) strongly reflects the shapes of the electrodes. Thus, the ions in the plasma collide hard against the MgO surface on the electrodes. In contrast, in the case in which the thickness of the dielectric layer 26 is large, the potential distribution in the discharge space (or the surface of the protective layer 27) is spatially dampened, thus the ions in the plasma collide against the MgO surface on the electrodes and the periphery thereof. Therefore, the discharge traces 62 are also generated at places slightly running off the electrodes.

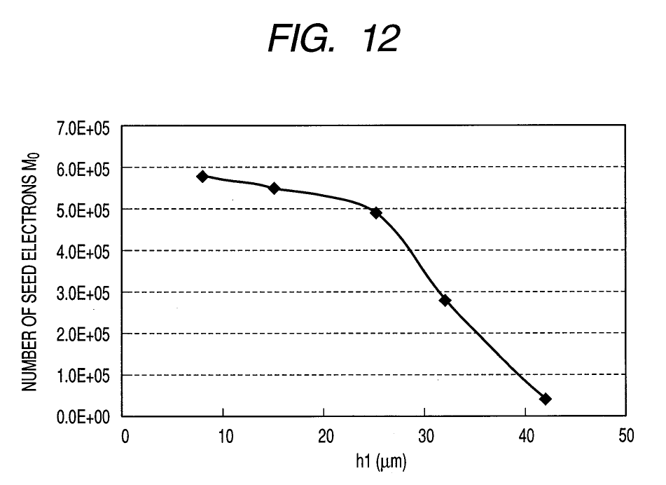

Here, it is preferable to prevent the sputtering of MgO on the floating electrodes 65 caused by the ion impact. Therefor, the number MO of the seed electrons after the life test was measured while varying the h1. The length of the dn is 16 μm. The results obtained are shown in FIG. 12. The h1 was varied to 42 μm, 32 μm, 25 μm, 15 μm, and 8 μm. It proves that the number M₀ of the seed electrons increases as the thickness of the dielectric layer decreases. Further, it is understood from the drawing that the number M0 of the seed electrons is rapidly decreased when the dielectric layer becomes thicker than 25 μm. This is because the extent of dampening in the potential distribution in the discharge space (or the surface of the protective layer 27) is enhanced.

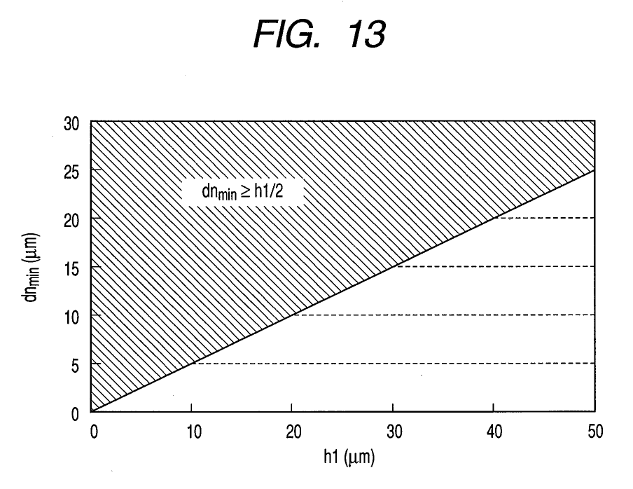

Here, the minimum value of the dn is assumed to be dnₘᵢₙ. The optimum range of the dnₘᵢₙ when the h1 is varied was considered. As described above, in the case in which the thickness of the dielectric layer 26 is large, the potential distribution in the discharge space (or the surface of the protective layer 27) is spatially dampened, thus the ions in the plasma collide against the MgO surface on the electrodes and the periphery thereof, and consequently, the discharge traces 62 run off the electrodes. The relationship between the length of the running off and the h1 was investigated. As a result, it proved that the length of the running off was roughly a half of the h1. Therefore, the dnₘᵢₙ is preferably longer than a half of the h1, and if the dnₘᵢₙ is shorter than a half of the h1, the influence of the sputtering by the ion impact becomes significant. According to this fact, the optimum relationship between the dnₘᵢₙ and h1 became clear. Specifically, the relationship can be represented by the following formula. Further, FIG. 13 shows the relationship as a shaded area.

$$\begin{matrix}\text{[Formula 11]} & \\ {dn}_{min} \geq \frac{h 1}{2} ( n = 1 , 2 , … , 12 ) & ( 11 )\end{matrix}$$

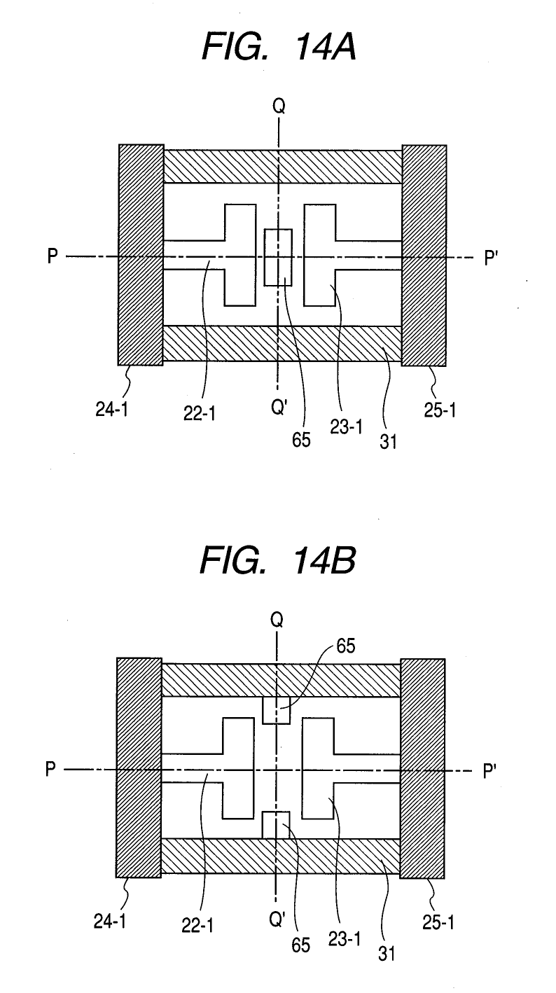

As shown in FIGS. 14A and 14B, a PDP having the floating electrode(s) disposed in the discharge cell was manufactured.

The h1 is 25 μm, and the dnₘᵢₙ is 13 μm. As shown in the drawings, the broken line P-P′ is drawn in parallel to the partition 31 (perpendicular to the X bus electrode 24-1 and the Y bus electrode 25-1) so as to pass through the center point of the discharge cell, and the broken line Q-Q′ is drawn in parallel to the X bus electrode 24-1 and the Y bus electrode 25-1 so as to pass through the center point of the discharge cell. FIG. 14A shows the PDP formed to have the floating electrode 65 disposed so as to pass through the center point of the discharge cell, and FIG. 14B shows the PDP formed to have the two identical floating electrodes 65 disposed along the Q-Q′ line and at positions furthest from the center point of the discharge cell within the effective discharge area. Here, the area of the floating electrode 65 shown in FIG. 14A and the total area of the two floating electrodes 65 shown in FIG. 14B were made equal. The life test for 1000 hours at 70 kHz was executed.

As a result, in the PDP shown in FIG. 14A, substantially the same result was obtained regarding the number M₀ of the seed electrons as the result in the case with the structure without the floating electrode 65 after the life test. After a detailed observation of the condition of the MgO surface on the floating electrode 65 in the discharge cell shown in FIG. 14A, the discharge traces were observed, and it proved that the crystallinity was lost from the MgO surface as shown in FIG. 7B. This is caused by the fact that in the case in which the floating electrode is disposed at the intersection of the lines P-P′ and Q-Q′, namely the center of the discharge cell, the discharge occurs also on the floating electrode 65 in the sustaining discharge, thus the ions collide against the MgO surface to cause deterioration of the MgO surface.

On the other hand, in the PDP shown in FIG. 14B, after the life test, there is obtained the effect of increasing the number M₀ of the seed electrons three times as many as the number in the case with the structure without the floating electrode 65. After a detailed observation of the condition of the MgO surface on the floating electrode in the discharge cell shown in FIG. 14B, almost no discharge traces was observed. It proved that the condition of the MgO surface was as shown in FIG. 7A, and almost no crystallinity was lost from the MgO surface. This was because the floating electrodes were disposed at the positions distant from the intersection of the lines P-P′ and Q-Q′, namely the center of the discharge cell and close to the partitions as shown in FIG. 14B, thereby making it possible to prevent the discharge from occurring on the floating electrodes 65 in the sustaining discharge, thus preventing the MgO surface from deteriorating. However, this advantage of the floating electrodes 65 is enhanced in the case in which the floating electrodes are located between the discharge gap and the X bus electrode 24-1 or the Y bus electrode 25-1 as the structure shown in FIG. 1 rather than the case in which the floating electrodes are located in the discharge gap between the X electrode 22-1 and the Y electrode 23-1. This is understood from the comparison of the number M₀ of the seed electrons after the life test described above.

The lengths of the floating electrodes 65 in the Q-Q′ direction (the lengths from the partitions 31 towards the center of the discharge cell along the Q-Q′ line) are preferably 20% of the length of the effective discharge area in the Q-Q′ direction (the length between the partitions 31 in the effective discharge area) from the respective sides. If the lengths exceed the desired values, the influence of the discharge sputtering in the sustaining discharge is exerted. Further, also in the structure shown in FIG. 14B, Formula 11 works out.

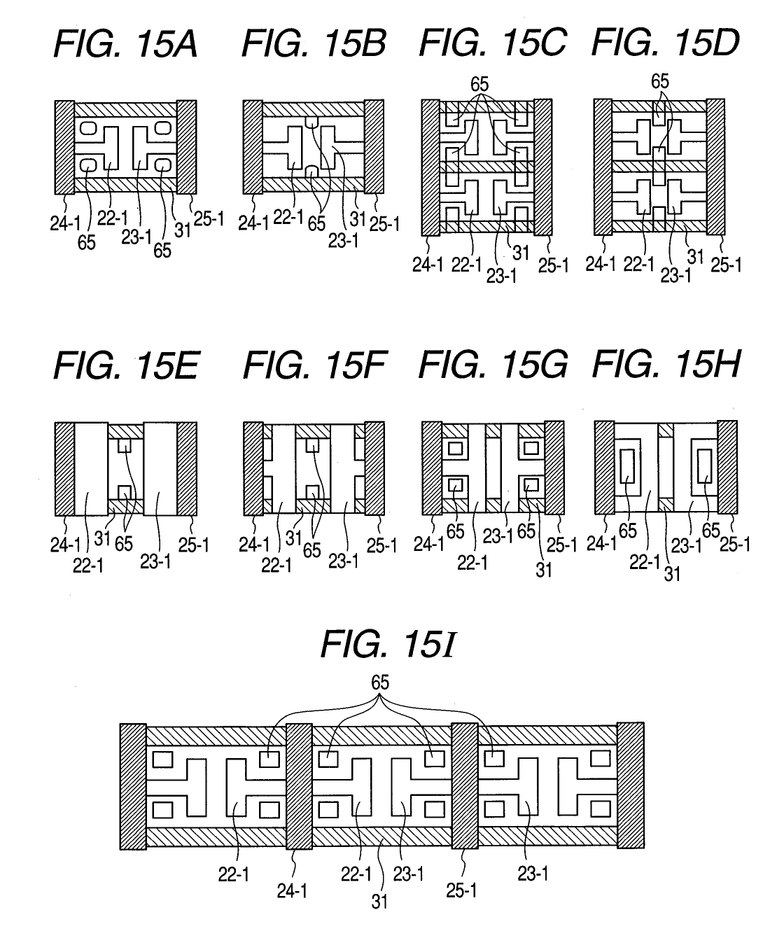

Further, although in the present embodiment, the shape of the floating electrode 65 is rectangular, it is obvious that the same advantages can be obtained by the floating electrode of any shapes such as shown in FIG. 15A, circle, ellipsoid, trapezoid, or polygon. Further, the same advantage can be obtained by disposing the floating electrodes at the positions shown in FIG. 15B. Further, it is also possible to dispose the floating electrode continuously in the adjacent discharge cells as shown in FIGS. 15C and 15D. Further the X electrode 22-1 and the Y electrode 23-1 can have the shapes as described in FIGS. 15E, 15F, 15G, and 15H. Further, the electrode structure in which the adjacent cells have a common X bus electrode 24-1 and a common Y bus electrode 25-1 as shown in FIG. 15I can also be adopted. Further, the discharge cell having a box type partition structure in which the partitions 31 are also formed in a direction parallel to the X bus electrode 24-1 and the Y bus electrode 25-1 so as to separating the discharge cells can also be adopted.

### Third Embodiment

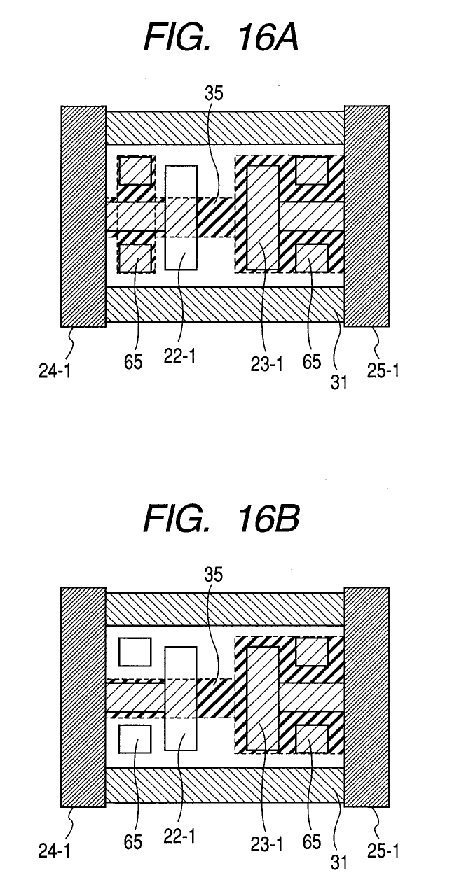

FIGS. 16A and 16B show an embodiment related to the present invention, and are diagrams showing an electrode structure of one discharge cell. In this electrode structure, an address electrode is disposed so that the overlapping of the Y electrode 23-1 and the floating electrode 65 with the opposed address electrode 35 becomes large. FIG. 16A is obtained by adding the address electrode to FIG. 1. A 42-inch PDP having such an electrode structure was manufactured. The thickness of the dielectric layer is 25 μm. The life test for 1000 hours at 70 kHz was executed on the PDP. As a result, the number M₀ of the seed electrons became 7.3×10⁵ after the life test. On the other hand, the structure shown in FIG. 16B is a target of comparison, in which the address electrode is formed so that the floating electrodes 65 on the X electrode 22-1 side do not overlap the address electrode. The number M₀ of the seed electrons in such a electrode structure became 4.9×10⁵ after the life test. From the results described above, it proves that the larger the overlapping between the floating electrodes and the address electrode opposed to each other, the larger the number of seed electrons becomes after the life test. Therefore, it proved that by increasing the overlapping between the floating electrodes and the address electrode, the deterioration in the address discharge timelag with age could be reduced.

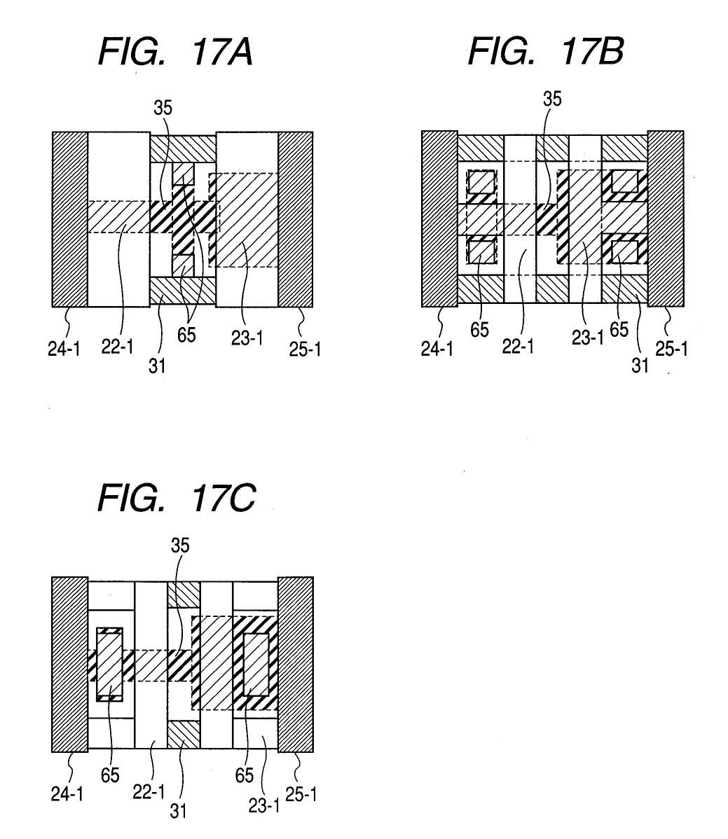

Further, it is obvious that by arranging the address electrode so that the overlapping of the Y electrode 23-1 and the floating electrodes with the address electrode becomes large as shown in FIGS. 17A, 17B, and 17C (corresponding respectively to FIGS. 15E, 15G, and 15H), the same advantage that the number of the seed electrons generated from the MgO surface is increased of increasing can be obtained. The structures described above are examples, and any shapes can be adopted providing the constituents are arranged so that the overlapping of the Y electrode 23-1 and the floating electrodes 65 with the address electrode 35 becomes large.

### Fourth Embodiment

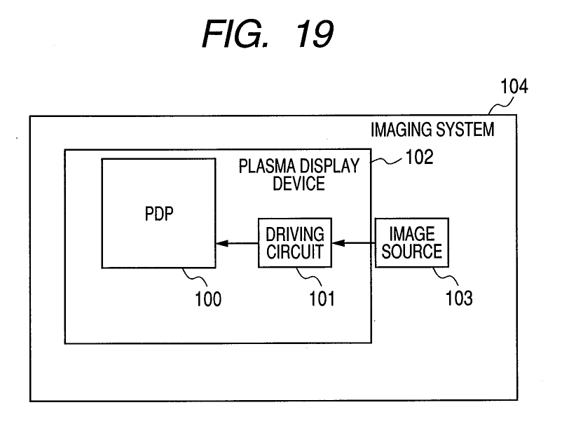

FIG. 19 shows an example showing a plasma display device using the PDP shown in the embodiment of the present invention as explained above, and an imaging system having the plasma display device and an image source connected to each other. A driving power supply (also referred to as a driving circuit) receives a signal of a display screen from the image source, and converts the signal into a driving signal of the PDP to drive the PDP.

What is claimed is:

1. A plasma display panel comprising:
a plurality of discharge cells each including
a front substrate,
a bus electrode,
a pair of sustaining discharge electrodes provided to the front substrate disposed in parallel to each other in a direction perpendicular to the longitudinal direction of the bus electrode, and for forming a display line,
a dielectric layer for covering the pair of sustaining discharge electrodes,
a rear substrate, and
an address electrode provided to the rear substrate so as to be opposed to the pair of sustaining discharge electrodes, and extending in a direction perpendicular to the longitudinal direction of the bus electrode; and
a plurality of partitions for separating the plurality of discharge cells,
wherein a floating electrode is disposed on the same substrate as the pair of sustaining discharge electrodes so as not to pass through a center line coplanar with the floating electrode extending in a direction perpendicular to the longitudinal direction of the bus electrode and dividing the discharge cell into two equal parts.

2. The plasma display panel according to claim 1,
wherein a length of the floating electrode in the longitudinal direction of one bus electrode is 20% of a width of the discharge cell in the longitudinal direction excluding the partitions.

3. The plasma display panel according to claim 1,
wherein the floating electrode is formed of one of a transparent conductive film and a metal film.

4. The plasma display panel according to claim 1,
wherein the floating electrode is formed in the same layer as the pair of sustaining discharge electrodes.

5. The plasma display panel according to claim 1,
wherein the floating electrode is made of the same material as the pair of sustaining discharge electrodes.

6. The plasma display panel according to claim 1,
wherein the dielectric layer is mainly composed of a grass layer, and an MgO film covering the glass layer.

7. The plasma display panel according to claim 1,
wherein the floating electrode is formed continuously to the contiguous discharge cell in the longitudinal direction of the bus electrode.

8. The plasma display panel according to claim 1,
wherein the shortest distance between the pair of sustaining discharge electrodes and the floating electrode is substantially a half of the thickness of the dielectric layer.

9. The plasma display panel according to claim 1,
wherein the thickness of the dielectric layer is equal to or smaller than 25 μm.

10. The plasma display panel according to claim 1,
wherein the address electrode is formed so that projective components of the floating electrode and the address electrode in a direction perpendicular to the rear substrate overlap with each other.

11. A plasma display panel comprising:
a plurality of discharge cells each including
a front substrate,
a bus electrode,
a pair of sustaining discharge electrodes provided to the front substrate disposed in parallel to each other in a direction perpendicular to the longitudinal direction of the bus electrode, and for forming a display line,
a dielectric layer for covering the pair of sustaining discharge electrodes so that the pair of sustaining discharge electrodes are opposed to each other with a predetermined gap,
a rear substrate, and
an address electrode provided to the rear substrate so as to be opposed to the pair of sustaining discharge electrodes, and extending in a direction perpendicular to the longitudinal direction of the bus electrode; and
a plurality of partitions for separating the plurality of discharge cells,
wherein the floating electrode is formed in another area than the gap.

12. The plasma display panel according to claim 11,
wherein the floating electrode is formed of one of a transparent conductive film and a metal film.

13. The plasma display panel according to claim 11,
wherein the floating electrode is formed in the same layer as the pair of sustaining discharge electrodes.

14. The plasma display panel according to claim 11,
wherein the floating electrode is made of the same material as the pair of sustaining discharge electrodes.

15. The plasma display panel according to claim 11,
wherein the dielectric layer is mainly composed of a grass layer, and an MgO film covering the glass layer.

16. The plasma display panel according to claim 11,
wherein the floating electrode is formed continuously to the contiguous discharge cell in the longitudinal direction of the bus electrode.

17. The plasma display panel according to claim 11,
wherein the shortest distance between the pair of sustaining discharge electrodes and the floating electrode is substantially a half of the thickness of the dielectric layer.

18. The plasma display panel according to claim 11,
wherein the thickness of the dielectric layer is equal to or smaller than 25 μm.

19. The plasma display panel according to claim 11,
wherein the address electrode is formed so that projective components of the floating electrode and the address electrode in a direction perpendicular to the rear substrate overlap with each other.
